(19) United States
(12) Patent Application Publication
(10) Pub. No.: US 2016/0051038 A1
(43) Pub. Date: Feb. 25, 2016

(54) ILLUMINATING BACKPACK

(71) Applicant: Jeremy Okulovich, Yuma, AZ (US)

(72) Inventor: Jeremy Okulovich, Yuma, AZ (US)

(21) Appl. No.: 14/464,677

(22) Filed: Aug. 20, 2014

(51) Int. Cl. A45F 4/02; A45F 3/04; F21V 23/04; F21L 4/08; F21V 33/00; F21L 4/02

(52) U.S. Cl. CPC A45F 4/02; F21V 33/0004; F21L 4/02; F21V 23/045; F21L 4/08; A45F 3/04; F21W 2131/30

(57) ABSTRACT

An illuminating backpack for producing an internal lighting source in a backpack that selectively illuminates the interior of the backpack to enable it to be visually inspected and provides decorative illumination visible from the outside of the backpack comprising a base backpack housing that includes two shoulder straps, a plurality of interior lighting elements, a battery component, and a remote control component. The plurality of interior lighting elements define a discrete columns of individual lighting elements which are electrically connected, with each column electrically connected to one another to form a complete lighting circuit that is electrically connected to the battery component through an infrared sensor of the remote control component. A switch in the infrared sensor is operated by the remote control component's infrared remote control, enabling a user to selectively provide electricity from the battery component to the lighting circuit components by manually actuating the remote control.

### BACKGROUND OF THE INVENTION

1. Field of the Invention

This invention relates generally to illuminating devices and, more particularly, to a backpack configured to illuminate through internal lighting.

2. Description of the Prior Art

The use and design of traditional backpacks, typically defined as a fabric sack carried on one's back and secured with two straps that go over the shoulders, is well known. While traditional backpacks are generally more suitable than handbags for carrying heavier loads or equipment, a problem which still exists is that the interior enclosure area of traditional backpacks typically relies solely on ambient lighting available in the general vicinity of the backpack or lighting from an additional device, such as a flashlight or mobile device to improve visibility. Consequently, if a user attempts to view the contents of a backpack at night or in dimly lit areas, the user may be unable to see or inspect the contents of the backpack. Thus, there remains a need for an illuminating backpack which would include built in lighting elements disposed in the interior of the backpack enclosure. It would be helpful if such an illuminating backpack included a built in, portable power supply to enable the lights to function independent exterior power sources. It would be additionally desirable for such an illuminating backpack to include lighting elements having sufficient luminance to be visible from the exterior of the backpack, providing a decorative element thereto. It would be further helpful for such an illuminating backpack to include a remote control that enabled the lights to be activated and deactivated by a user while the back was worn.

The Applicant's invention described herein provides for an illuminating backpack adapted to include a plurality of internal lighting elements powered by a portable power supply and controlled by a remote control. The primary components in Applicant's illuminating backpack are a backpack housing, a plurality of lights, a battery component, and a remote control component. When in operation, the illuminating backpack enables the interior of the backpack to be illuminated to enable a user to see inside as well as the exterior of the backpack to be illuminated for decorative purposes. As a result, many of the limitations imposed by prior art structures are removed.

### SUMMARY OF THE INVENTION

An illuminating backpack for producing an internal lighting source in a backpack that selectively illuminates the interior of the backpack to enable it to be visually inspected and provides decorative illumination visible from the outside of the backpack. The illuminating backpack comprising a base backpack housing that includes two shoulder straps, a plurality of interior lighting elements, a battery component, and a remote control component. In the preferred embodiment, the plurality of interior lighting elements define a discrete columns of individual lighting elements which are electrically connected, with each column electrically connected to one another to form a complete lighting circuit that is electrically connected to the battery component through an infrared sensor of the remote control component. A switch in the infrared sensor is operated by the remote control component's infrared remote control, enabling a user to selectively provide electricity from the battery component to the lighting circuit components by manually actuating the remote control.

It is an object of this invention to provide an illuminating backpack which includes built in lighting elements disposed in the interior of the backpack enclosure.

It is another object of this invention to provide an illuminating backpack that includes a built in, portable power supply to enable the lights to function independent exterior power sources.

It is yet another object of this invention to provide an illuminating backpack that includes lighting elements having sufficient luminance to be visible from the exterior of the backpack, providing a decorative element thereto.

It is still another object of this invention to provide an illuminating backpack that includes a remote control that enabled the lights to be activated and deactivated by a user while the back was worn.

These and other objects will be apparent to one of skill in the art.

### BRIEF DESCRIPTION OF THE DRAWINGS

FIG. 1 is a side perspective view of an illuminating backpack built in accordance with the present invention having its lights illuminated.

FIG. 2 is a top plan view of the interior of an illuminating backpack built in accordance with the present invention.

### DETAILED DESCRIPTION OF THE INVENTION

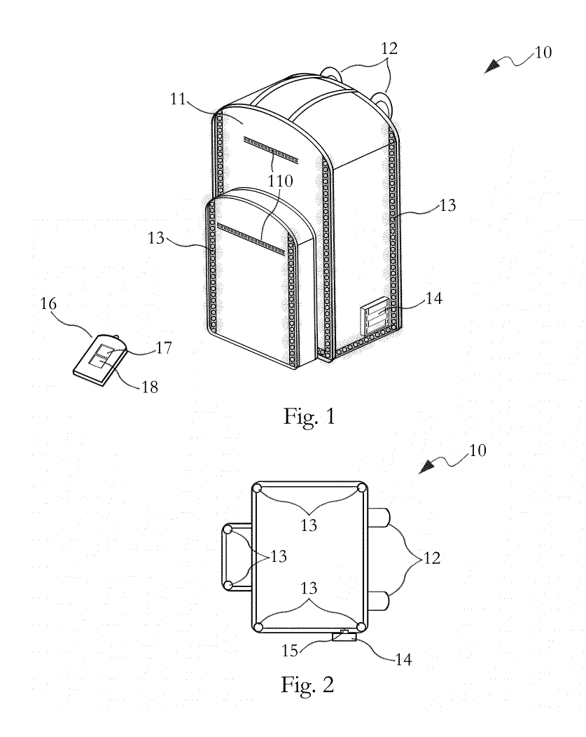

Referring now to the drawings and in particular FIGS. 1 and 2, an illuminating backpack 10 is shown having a base backpack housing 11 which includes two shoulder straps 12, a plurality of interior lighting elements 13, a battery component 14, and a remote control component. The base backpack housing 11 is embodied as a conventional backpack housing defined by a fabric sack enclosure suitable for use to contain items and be worn over a users shoulders as conventional backpacks are. In this regard, it includes a plurality of zippers 110 which provide selective access to the interior of the base backpack housing 11.

The plurality of interior lighting elements 13 define a plurality of columns of discrete lighting elements which are electrically connected in series, with each column electrically connected to one another to form a complete lighting circuit. The lighting circuit is electrically connected to an infrared sensor 15 of the remote control component, and the infrared sensor 15 is electrically connected to the battery component 14.

In the preferred embodiment, the battery component 14 is defined by a housing that receives eight (8) AA batteries that collectively supply electrical power to the lighting circuit. The infrared sensor 15 includes an internal infrared sensor apparatus and an electrical switch that selectively provides power to the lighting circuit. The switch in the infrared sensor 15 is operated by a infrared remote control 16 that defines a wireless manual actuator of the infrared sensor 15. The remote control 16 is structured to receive user actuation through an on actuation button 17 and an off actuation button 18. In this regard, when the on actuation button 17 is engaged by a user, the infrared sensor 15 receives an infrared signal from the remote control 16 which opens the electrical switch of the infrared sensor 15, enabling electricity from the battery component 14 to pass through the infrared sensor 15 to the lighting circuit, causing the plurality of interior lighting elements 13 to illuminate. The plurality of interior lighting elements 13 remain illuminated until the off actuation button 18 is engaged by a user, which causes the remote control 16 to send an infrared signal to the infrared sensor 15 which closes the electrical switch of the infrared sensor 15, terminating all electricity from the battery component 14 to the lighting circuit.

In one embodiment, the infrared sensor 15 includes a local actuator for receiving manual actuation from a user to open and close the electrical switch.

In an alternate embodiment, the plurality of lighting elements are disposed in the base backpack housing in decorative arrangements.

In one embodiment, the plurality of interior lighting elements are defined by one or more elongated lighting strips.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An illuminating backpack, comprising:
a base backpack housing having an exterior surface, at least one interior compartment, and at least one shoulder strap attached to its exterior surface;
a plurality of interior lighting elements disposed in the interior compartment, wherein said plurality of interior lighting elements are electrically interconnected;
a battery component electrically connected to said plurality of lighting elements, wherein said battery compartment is configured to provide electricity to said plurality of lighting components; and
a control component comprising an electrical switch, wherein said control component is connected to said plurality of interior lighting elements and said battery component and is operative to selectively avail electricity from said battery component to said plurality of interior lighting elements and terminate electricity from said battery component to said plurality of interior lighting elements.

2. The illuminating backpack of claim 1, wherein said plurality of interior lighting elements are defined by a plurality of columns of discrete lighting elements which are electrically connected in series.

3. The illuminating backpack of claim 1, wherein said battery compartment is disposed on the exterior surface.

4. The illuminating backpack of claim 1, wherein said battery compartment includes at least one removable battery.

5. The illuminating backpack of claim 1, wherein said battery compartment includes at least one rechargeable battery.

6. The illuminating backpack of claim 1, wherein said control component additionally comprises a wireless signal sensor apparatus connecting said electrical switch with a wireless signal sensor.

7. The illuminating backpack of claim 6, wherein said control component additionally comprises a remote control apparatus operative to receive manual actuation and send wireless signals to said wireless signal sensor that cause the electrical switch to avail and terminate electricity from said battery component to said plurality of interior lighting elements.
